(19) United States
(12) Patent Application Publication
(10) Pub. No.: US 2017/0284818 A1
(43) Pub. Date: Oct. 5, 2017

(54) SHARING ROUTE INFORMATION WITHIN A GROUP OF TRAVELERS

(71) Applicant: International Business Machines Corporation, Armonk, NY (US)

(72) Inventors: Gregory J. Boss, Saginaw, MI (US); Andrea Macias Garcia, Escazu (CR); Stephen J. McConnell, Millisle (GB); Piotr Pierga, Palatine, IL (US); Stacey C. Ramos, Dallas, TX (US); Diego Xirinachs Jimenez, San Vicente (CR)

(21) Appl. No.: 15/086,269

(22) Filed: Mar. 31, 2016

(51) Int. Cl. G01C 21/34; H04W 4/08

(52) U.S. Cl. CPC G01C 21/3438; H04W 4/08

(57) ABSTRACT

A method and system for sharing route information within a group of travelers is provided. The method includes a subscriber device requesting to join a route to a destination created by a master device. Once the subscriber device has joined the route, the subscriber device receives periodic updates to the route. At any point in time, the subscriber device can request to change roles with the master device, where the subscriber device takes on the role of the new master, and the former master device becomes a subscriber or follower.

### BACKGROUND OF THE INVENTION

The present invention relates generally to the field of navigation data communication, and more particularly to systems and methods for sharing route information between a master device and subscriber device(s) within a group of travelers.

When a group of individuals are traveling to a common destination using independent navigation systems, each navigation system may plot different routes to the same destination, which allow the group to arrive at the same point, but not necessarily using the same route during the journey. Sometimes, the group would prefer to stay together for various reasons (e.g., safety, simultaneous travel, etc.). It is also possible that emergency stops, rest stops, and traffic conditions may contribute to the group of individuals becoming separated over time during the course of the route.

### SUMMARY

According to an embodiment of the present invention, a method for sharing route information is provided. The method comprises: requesting, by one or more subscriber devices, to join a route to a destination, created by a master device; receiving, by the one or more subscriber devices, updates to the created route to the destination from the master device; requesting, by a subscriber device from the one or more subscriber devices, a role change to a role of the master device; and responsive to a confirmation of the role change from the master device, configuring the requesting subscriber device to the role of the master device.

Another embodiment of the present invention provides a computer program product for sharing route information, based on the method described above.

Another embodiment of the present invention provides a computer system for sharing route information, based on the method described above.

### BRIEF DESCRIPTION OF THE DRAWINGS

FIG. 1 depicts a functional block diagram of a synchronized travel route environment, in accordance with an embodiment of the present invention;

FIG. 2 depicts a flowchart illustrating operational steps for creating a synchronized route, in accordance with an embodiment of the present invention;

FIG. 3 depicts a flowchart illustrating operational steps for joining a created synchronized route, in accordance with an embodiment of the present invention;

FIG. 4 depicts a flowchart illustrating operational steps for maintaining a route where the final destination of the synchronized route is the current location of the master device, in accordance with an embodiment of the present invention;

FIG. 5 depicts a flowchart illustrating operational steps for maintaining a route where the route of the master device is the final destination, in accordance with an embodiment of the present invention;

FIG. 6 depicts a flowchart illustrating operational steps for automatically changing the device role from subscriber to master, in accordance with an embodiment of the present invention;

FIG. 7 depicts a flowchart illustrating operational steps for requesting a change in device role from a subscriber to a master, in accordance with an embodiment of the present invention; and

FIG. 8 depicts a block diagram of components of a computing device, in accordance with an illustrative embodiment of the present invention.

### DETAILED DESCRIPTION

A group of travelers in separate vehicles may want to stay together on a journey, which can sometimes be accomplished by entering the same destination in each navigation system within the group. However, factors such as traffic conditions, special configurations on the navigation systems, and different driving styles may lead to the group becoming separated over time. In addition, if one or more travelers takes a detour or rest stop, the other travelers may not know, or may not be able to reprogram their navigation devices while driving. Embodiments of the present invention provide systems and methods for a group of travelers to share route information and to stay together during the course of a journey to a same destination using independent GPS units, in which a ‘master/subscriber’ relationship is created between the navigation devices, allowing each ‘subscriber’ device to be routed to follow the same course, time, and waypoints as the master device.

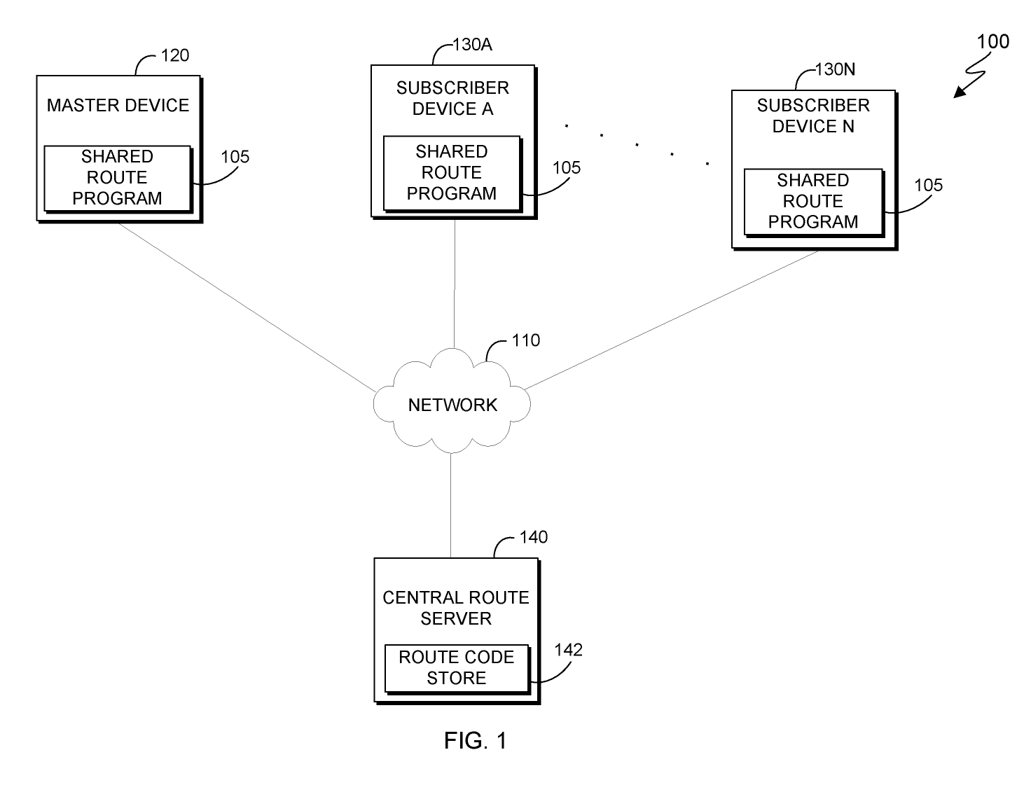

The present invention will now be described in detail with reference to the Figures. FIG. 1 depicts a functional block diagram illustrating a synchronized travel route environment, generally designated 100, in accordance with an embodiment of the present invention. Modifications to synchronized travel route environment 100 may be made by those skilled in the art without departing from the scope of the invention as recited by the claims. In an exemplary embodiment, synchronized travel route environment 100 includes master device 120, subscriber devices 130A-N, and central route server 140, all interconnected by network 110.

The term “operator” as used herein refers to the person using the navigation device. The operator may be a driver of an automobile, a hiker, a biker, an airplane pilot, a boat operator, or any other person capable of operating a navigation device. For purposes of the present disclosure, it is assumed that each of master device 120 and subscriber devices 130A-N has a different operator, it being understood that a subscriber device 130A-N can become the master device 120 at any point in time, and the master device 120 can become a subscriber device 130A-N (discussed in further detail below). For purposes of the present disclosure, it is assumed that each of master device 120 and subscriber devices 130A-N are located on or near an operator, or within a vehicle (e.g., automobile, airplane, boat, etc.) of an operator.

Master device 120 and subscriber devices 130A-N each include shared route program 105. In this exemplary embodiment, master device 120 and subscriber devices 130A-N are navigation devices. In various embodiments of the present invention, master device 120 and subscriber devices 130A-N can take the form of a laptop computer, a tablet computer, a netbook computer, a personal computer (PC), a desktop computer, a personal digital assistant (PDA), a smart phone, a thin client, a wearable device, or any programmable mobile electronic device capable of executing computer readable program instructions. Master device 120 is a single navigation device within a group of navigation devices, which is charged with plotting the course, waypoints, and destination location. Subscriber devices 130A-N are one or more devices within a group of navigation devices, which receives route information from master device 120. In this exemplary embodiment, both master device 120 and subscriber devices 130A-N provide a user interface (not depicted in FIG. 1) to the operator of the device.

Shared route program 105 is a software program which allows updates to be sent and received from each of master device 120 and subscriber devices 130A-N in real time. Shared route program 105 syncs the navigation devices, shares route codes, and receives the initial route details from central route server 140. Shared route program 105 can detect the distance between each of the other navigation devices and the created route, and can provide an option for switching the role of each device (e.g., the master device 120 can become a subscriber device 130A-N, and a subscriber device 130A-N can become the master device 120).

Network 110 can be, for example, a local area network (LAN), a wide area network (WAN) such as the Internet, the public switched telephone network (PSTN), a mobile data network (e.g., wireless Internet provided by a third or fourth generation of mobile phone mobile communication), a private branch exchange (PBX), any combination thereof, or any combination of connections and protocols that will support communications between master device 120 and subscriber devices 130A-N, in accordance with an embodiment of the present invention. Network 110 may include wired, wireless, or fiber optic connections.

Central route server 140 includes route code store 142. Central route server 140 can receive a created route from a master device 120 and provide a unique route code to the master device 120. Each of subscriber devices 130A-N can look up the unique code in route code store 142. Central route server 140 can update all devices with a change to the route and can monitor the position of each device with respect to the created route. In response to detecting a sufficient deviation from the route by one of the navigation devices, central route server 140 can modify the route as needed. Central route server 140 can receive requests from devices to change the role of the devices (i.e., request for a subscriber to become a master) and can determine which device is the current master device, based on responses received from the devices (e.g., accept or deny a request to change a device role).

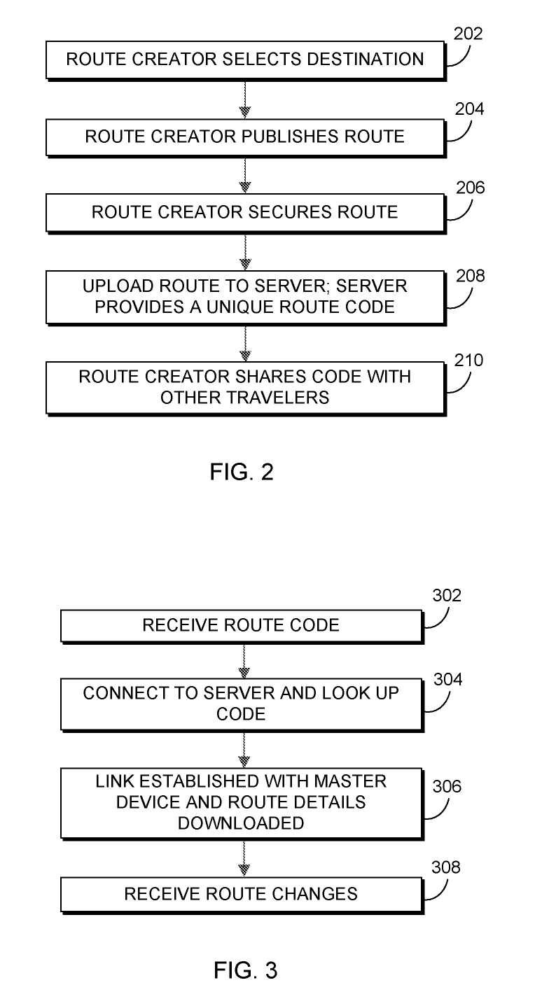

FIG. 2 depicts a flowchart illustrating operational steps for creating a synchronized route, in accordance with an embodiment of the present invention. For purposes of the present disclosure, the initial operator of the master device 120 is assumed to be the route creator, and a traveler is assumed to be an operator of one of subscriber devices 130A-N.

In step 202, a route creator uses a navigation device (i.e., the master device) to select a destination. In some embodiments, the route creator may be required to confirm a particular route to the selected destination.

In step 204, the route creator publishes the route. In this exemplary embodiment, the route creator may use an option on their navigation device to publish the selected route.

In step 206, the route creator secures the route. In this exemplary embodiment, the route creator may input a password to secure their route. In other embodiments, the route creator may specify which other travelers are invited or authorized to use the created route.

In step 208, the created route is uploaded to a central server and a unique route code is provided. In this exemplary embodiment, the navigation device of the route creator uploads the selected route to central route server 140, and central route server 140 confirms receipt of the route and provides the route creator with a unique route code. For example, the unique route code may be a URL.

In step 210, the route creator shares the unique route code with other travelers. In some embodiments, when other travelers have been preauthorized to access the route code (i.e., step 206), the route creator may simply invite the travelers to access the route code, without the need for a password to access the created route.

FIG. 3 depicts a flowchart illustrating operational steps for joining a created synchronized route, in accordance with an embodiment of the present invention. It should be noted that embodiments of the present invention do not require that a traveler is on the original route before joining the group (i.e., a traveler can join the route after it has begun).

In step 302, a navigation device receives a unique route code, input by a traveler, such as a URL.

In step 304, the navigation device connects to the central server and looks up the entered route code. In this exemplary embodiment, central route server 140 requests a password or other type of authentication. The traveler must then enter the password that was shared by the route creator.

In step 306, a link is established between the subscriber device 130A-N and the master device 120 (i.e., the device used by the route creator to create the route), and the subscriber device 130A-N downloads the details of the created route from central route server 140.

In step 308, the subscriber device 130A-N receives route changes. In this exemplary embodiment, subscriber device 130A-N may receive route changes periodically as they are made or as they are updated by the route creator, from central route server 140. In some embodiments, the master device 120, as well as any synchronized subscriber device 130A-N can make an update to the route (e.g., request an unplanned stop, make a detour). The master device 120 can then accept or deny a request to update the route received from a subscriber device 130A-N.

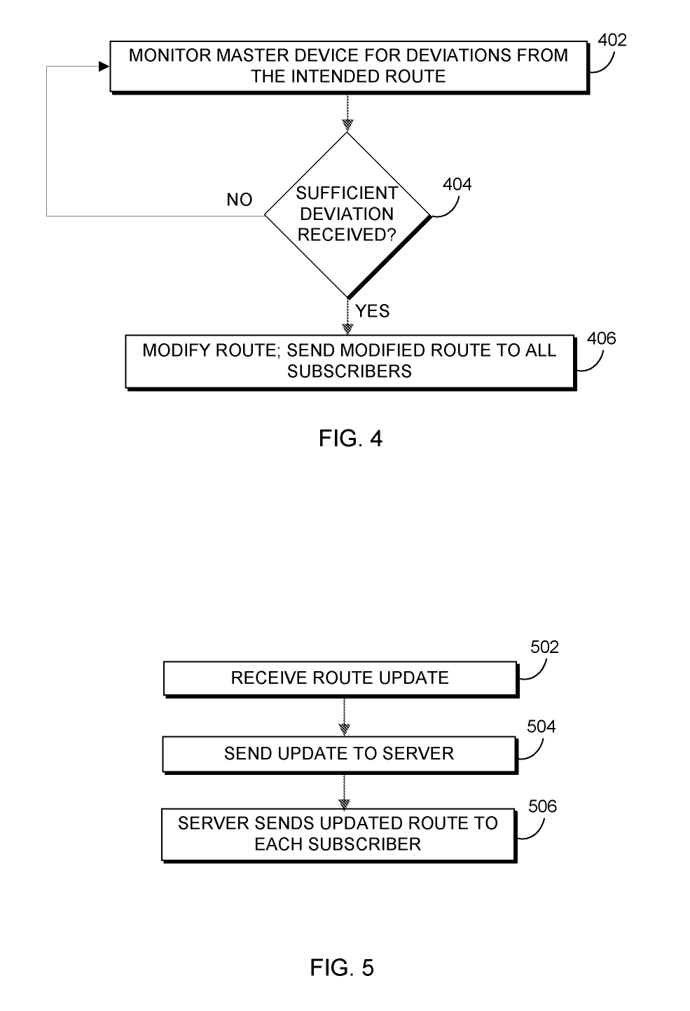

Due to various real world conditions, such as traffic, operator skills, or speed of the various vehicles, the group of operators may or may not be within close proximity to each other. Embodiments of the present invention disclose two methods of keeping the group of operators together. In the first method, the master device's location is used as the destination, and establishes the location of master device 120 as the destination for subscriber devices 130A-N (i.e., the operational steps of FIG. 4). In the second method, the master's route is the destination, and the waypoints, route, and destination of master device 120 are established as the waypoints, route, and destination of subscriber devices 130A-N (described further with respect to FIG. 5).

FIG. 4 depicts a flowchart illustrating operational steps for maintaining a route where the final destination of the synchronized route is the current location of the master device, in accordance with an embodiment of the present invention. Each of subscriber devices 130A-N is updated in real time, as the master device (i.e., route creator) makes modifications to the original route.

In step 402, the central server monitors the master device for a deviation from the intended route. In this exemplary embodiment, the master device constantly sends out current location updates to central route server 140. Central route server 140 receives these updates, and monitors the master device for position changes or deviations from the intended route.

In step 404, the central server determines whether a sufficient deviation from the intended route has been received. A degree of allowable deviation from the created route may be predetermined by the route creator, or may be a default setting on the navigation device. Central route server 140 monitors the distance between the master device 120 and the intended route, and detects when the predetermined, allowable degree of deviation from the intended route has been surpassed by the master device 120. For example, if the intended route is a freeway, and a 30 meter deviation is the allowable degree of deviation, then if the master device takes an unexpected deviation by exiting from the freeway and driving toward a gas station, the system will update the route on each of the other subscriber devices 130A-N to deviate toward the same gas station.

If central route server 140 determines that a sufficient deviation from the intended route has been received, then, in step 406, central route server 140 modifies the route, and sends the modified route to each synchronized subscriber device 130A-N. For example, if the master device decides to pull off a freeway and stop for gas, each of the other subscriber devices 130A-N will receive a waypoint modification or deviation that directs them off the freeway to the same gas station at which the master device has stopped. Thus, the master device's current location is the destination for each of the other subscribed travelers in the group.

FIG. 5 depicts a flowchart illustrating operational steps for maintaining a route where the route of the master device is the final destination, in accordance with an embodiment of the present invention. This method allows the master device to update the intended route without the requirement that they are the lead vehicle.

In step 502, the master device 120 receives an update to the route. In this exemplary embodiment, the master device 120 includes a feature which allows the route creator to make updates to the route, while the route is in progress.

In step 504, the master device 120 sends the updated route to central route server 140.

In step 506, central route server 140 sends the updated route to each synchronized subscriber device 130A-N. For example, a master device 120 may want to have all subscribers to the route to get an update while the master device makes a momentary deviation (e.g., pulls off at a rest stop for a few minutes with plans to catch up later).

In other embodiments of the present invention, each of master device 120 and subscriber devices 130A-N may follow a different route to reach the same destination. For example, for a group of travelers each starting at a different location (i.e., their respective homes) and all meeting at the movies (i.e., the destination), shared route program 105 may synchronize the intended route, so that each of the travelers meets at the same destination at the same time (though each traveler has followed a different route). In this example, shared route program 105 is still able to coordinate rest stops or other travel conditions along the route, in order for each traveler to arrive at the destination at the same time.

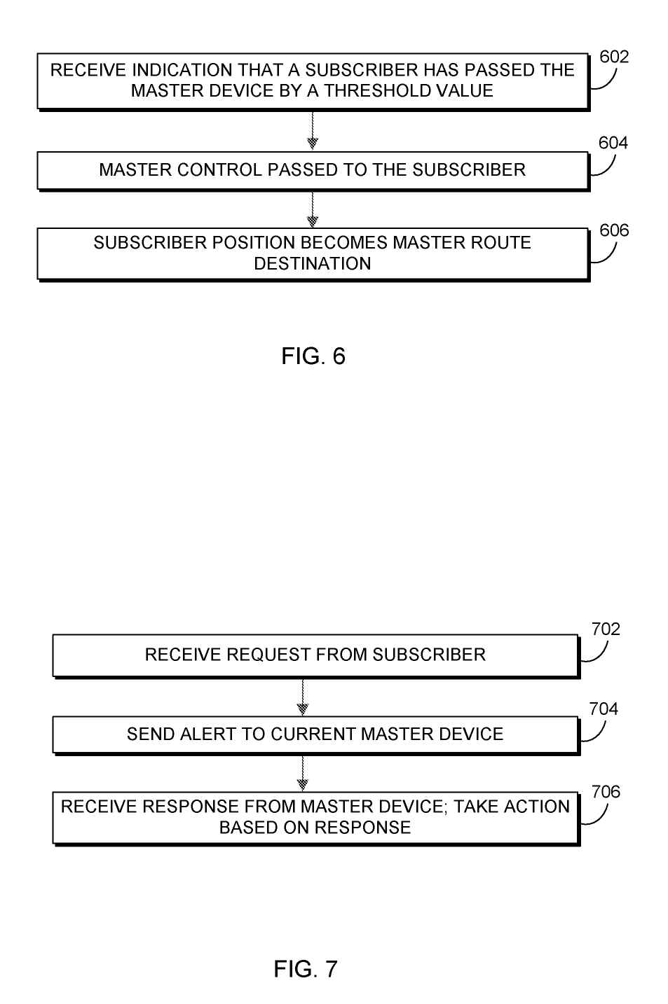

FIG. 6 depicts a flowchart illustrating operational steps for automatically changing the device role from subscriber to master, in accordance with an embodiment of the present invention. In some cases it may become necessary for a subscriber to assume the master's role and associated privileges to update a route (i.e., an ‘emergency takeover’). For example, if the master vehicle is pulled over by a police officer, rather than each subscriber vehicle pulling over as well, one subscriber can take over the master control.

In step 602, master device 120 receives an indication that a subscriber device 130A-N has passed the master device 120 by more than a threshold distance. In this exemplary embodiment, master device 120 continuously monitors each vehicle in the route caravan. If any vehicle in the route caravan passes the master device vehicle by greater than a predetermined threshold distance (e.g., 100 meters), then an indication is sent to the master device, as well as the device of the passing vehicle.

In step 604, master control is passed to the subscriber. In this exemplary embodiment, master control is automatically passed from the master device to the subscriber which has passed the master device's vehicle in the route. In some embodiments, the navigation device of the subscriber will provide an indication for the subscriber to accept the new master control. In this exemplary embodiment, the master control is passed to the subscriber who has physically passed the master device's vehicle, and this same rule (i.e., physically passing the master vehicle) will pass master control back to the original master device or another subscriber; otherwise the new master who first took the master role will indefinitely remain the master.

In step 606, the subscriber's position becomes the new master route destination. In this exemplary embodiment, if the vehicle systems are operating under the operational steps of FIG. 4 (i.e., maintaining a route where the final destination of the synchronized route is the current location of the master device), then the subscriber's position becomes the new master route destination. If the vehicle systems are operating under the operational steps of FIG. 5 (i.e., maintaining a route where the route of the master device is the final destination), then the route of the subscriber (who has become the new master in step 604) becomes the new master route. In some embodiments, one of subscriber devices 130A-N can assume the role of master device 120 (i.e., becomes the new master device), and divert the operators of the other subscriber devices 130A-N to a location. For example, the new master device can ‘lead from behind’, diverting the other subscriber devices 130A-N to a location not on the original, created route, such as an unexpected detour/stop at a historical marker or an unexpected detour/stop at a rest stop.

FIG. 7 depicts a flowchart illustrating operational steps for requesting a change in device role from a subscriber to a master, in accordance with an embodiment of the present invention.

In step 702, central route server 140 receives a request from a subscriber to take over the master route. In this exemplary embodiment, a request is received at central route server 140 that a subscriber device 130A-N would like to become the master device 120. For example, a subscriber may request to take the master control by pressing a particular button, or providing a voice command.

In step 704, central route server 140 acknowledges the request from a subscriber, and sends an alert to the current master device. In this exemplary embodiment, an alert is sent to the master navigation device, requesting the master relinquish the route control to another subscriber. The master can then either confirm the request, or deny the request, by, for example, pressing a button or giving an audio/voice command.

In step 706, central route server 140 receives the response of the master device, and takes the appropriate action based on the response. For example, if, in step 704, the master device 120 confirmed the request to relinquish control to a subscriber device 130A-N, then central route server 140 determines that the subscriber now has the master control.

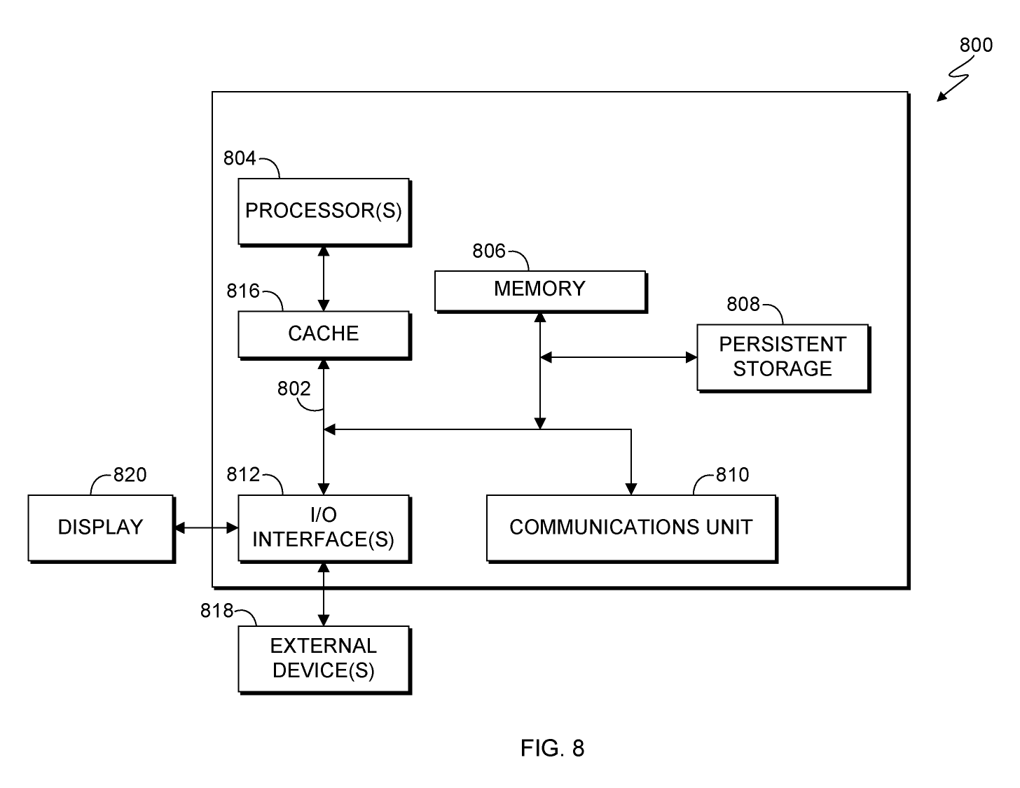

FIG. 8 depicts a block diagram of internal and external components of a computing device, generally designated 800, which is representative of components of FIG. 1, in accordance with an embodiment of the present invention. It should be appreciated that FIG. 8 provides only an illustration of one implementation and does not imply any limitations with regard to the environments in which different embodiments may be implemented. Many modifications to the depicted environment may be made.

Computing device 800 includes communications fabric 802, which provides communications between computer processor(s) 804, memory 806, cache 816, persistent storage 808, communications unit 810, and input/output (I/O) interface(s) 812. Communications fabric 802 can be implemented with any architecture designed for passing data and/or control information between processors (such as microprocessors, communications and network processors, etc.), system memory, peripheral devices, and any other hardware components within a system. For example, communications fabric 802 can be implemented with one or more buses.

Memory 806 and persistent storage 808 are computer-readable storage media. In this embodiment, memory 806 includes random access memory (RAM). In general, memory 806 can include any suitable volatile or non-volatile computer readable storage media. Cache 816 is a fast memory that enhances the performance of processors 804 by holding recently accessed data, and data near recently accessed data, from memory 806.

Program instructions and data used to practice embodiments of the present invention may be stored in persistent storage 808 and in memory 806 for execution by one or more of the respective processors 804 via cache 816. In an embodiment, persistent storage 808 includes a magnetic hard disk drive. Alternatively, or in addition to a magnetic hard disk drive, persistent storage 808 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 808 may also be removable. For example, a removable hard drive may be used for persistent storage 808. Other examples include optical and magnetic disks, thumb drives, and smart cards that are inserted into a drive for transfer onto another computer readable storage medium that is also part of persistent storage 808.

Communications unit 810, in these examples, provides for communications with other data processing systems or devices, including resources of a network. In these examples, communications unit 810 includes one or more network interface cards. Communications unit 810 may provide communications through the use of either or both physical and wireless communications links. Program instructions and data used to practice embodiments of the present invention may be downloaded to persistent storage 808 through communications unit 810.

I/O interface(s) 812 allows for input and output of data with other devices that may be connected to computing device 800. For example, I/O interface 812 may provide a connection to external devices 818 such as a keyboard, keypad, a touch screen, and/or some other suitable input device. External devices 818 can also include portable computer-readable storage media such as, for example, thumb drives, portable optical or magnetic disks, and memory cards. Software and data used to practice embodiments of the present invention (e.g., software and data) can be stored on such portable computer-readable storage media and can be loaded onto persistent storage 808 via I/O interface(s) 812. I/O interface(s) 812 also connect to a display 820.

Display 820 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A method for sharing route information, comprising the steps of:
requesting, by one or more subscriber devices, to join a route to a destination, created by a master device;
receiving, by the one or more subscriber devices, updates to the created route to the destination from the master device;
requesting, by a subscriber device from the one or more subscriber devices, a role change to a role of the master device;
responsive to a confirmation of the role change from the master device, configuring the requesting subscriber device to the role of the master device;
using a location of the master device as the destination of the one or more subscriber devices; and
responsive to confirming the role change of the subscriber device from the one or more subscriber devices to the master device, using a location of the subscriber device as the destination of the one or more subscriber devices.

2. The method of claim 1, further comprising:
determining, by one or more processors, whether a predetermined threshold deviation from the created route, by the master device, has occurred;
in response to determining that a predetermined threshold deviation from the created route, by the master device, has occurred, modifying, by one or more processors, created routes, based on a deviation; and
sending, by one or more processors, the modified route to the one or more subscriber devices.

3. The method of claim 2, further comprising:
responsive to a subscriber device from one or more subscriber devices undergoing a role change to the master device, sending the modified route to the one or more subscriber devices.

4. The method of claim 1, wherein the route of the master device is used as the destination of the one or more subscriber devices, and wherein the master device is not in a lead position among a group of travelers.

5. The method of claim 1, further comprising:
generating, by one or more processors, a code associated with the created routes;
in response to receiving the code from the one or more subscriber devices, establishing, by one or more processors, an operative link between the master device and the one or more subscriber devices; and
sending, by one or more processors, information associated with the created route.

6. The method of claim 1, wherein requesting, by the subscriber device from the one or more subscriber devices, the role change to the role of the master device comprises:
responsive to detecting that the subscriber device from the one or more subscriber devices has physically passed the master device by greater than a predetermined threshold distance, configuring, by one or more processors, the subscriber device from the one or more subscriber devices, to the role of the master device.

7. The method of claim 2, wherein the master device and the one or more subscriber devices follow a different route to a same destination, and wherein the master device and the one or more subscriber devices each start at a different location.

8. A computer program product for sharing route information, comprising:
a computer readable storage medium and program instructions stored on the computer readable storage medium, the program instructions comprising:
program instructions to request to join a route to a destination, created by a master device;
program instructions to receive updates to the created route to the destination from the master device;
program instructions to request a role change to a role of the master device;
program instructions to, responsive to a confirmation of the role change from the master device, configure a requesting subscriber device to the role of the master device;
program instructions to use a location of the master device as the destination of the one or more subscriber devices; and
responsive to confirming the role change of the subscriber device from the one or more subscriber devices to the master device, program instructions to use a location of the subscriber device as the destination of the one or more subscriber devices.

9. The computer program product of claim 8, further comprising:
program instructions to determine whether a predetermined threshold deviation from the created route, by the master device, has occurred;
program instructions to, in response to determining that a predetermined threshold deviation from the created route, by the master device, has occurred, modify the created route, based on a deviation; and
program instructions to send the modified route to one or more subscriber devices.

10. The computer program product of claim 9, further comprising:
responsive to a subscriber device from one or more subscriber devices undergoing a role change to the master device, sending the modified route to the one or more subscriber devices.

11. The computer program product of claim 8, wherein the route of the master device is used as the destination of one or more subscriber devices, and wherein the master device is not in a lead position among a group of travelers.

12. The computer program product of claim 8, further comprising:
program instructions to generate a code associated with the created route;
program instructions to, in response to receiving the code from one or more subscribers devices, establish an operative link between the master device and the one or more subscriber devices; and
program instructions to send information associated with the created route.

13. The computer program product of claim 8, wherein program instructions to request the role change to the role of the master device comprise:
responsive to detecting that the subscriber device from the one or more subscriber devices has physically passed the master device by greater than a predetermined threshold distance, program instructions to configure the subscriber device from the one or more subscriber devices, to the role of the master device.

14. The computer program product of claim 9, wherein the master device and the one or more subscriber devices follow a different route to a same destination, and wherein the master device and the one or more subscriber devices each start at a different location.

15. A computer system for sharing route information, comprising:
one or more computer processors;
one or more computer readable storage media;
program instructions stored on the one or more computer readable storage media for execution by at least one of the one or more processors, the program instructions comprising:
program instructions to request to join a route to a destination, created by a master device;
program instructions to receive updates to the created route to the destination from the master device;
program instructions to request a role change to a role of the master device;
program instructions to, responsive to a confirmation of the role change from the master device, configure a requesting subscriber device to the role of the master device;
program instructions to use a location of the master device as the destination of the one or more subscriber devices; and
responsive to confirming the role change of the subscriber device from the one or more subscriber devices to the master device, program instructions to use a location of the subscriber device as the destination of the one or more subscriber devices.

16. The computer system of claim 15, further comprising:
program instructions to determine whether a predetermined threshold deviation from the created route, by the master device, has occurred;
program instructions to, in response to determining that a predetermined threshold deviation from the created route, by the master device, has occurred, modify the created route, based on a deviation; and
program instructions to send the modified route to one or more subscriber devices.

17. The computer system of claim 16, further comprising:
responsive to a subscriber device from one or more subscriber devices undergoing a role change to the master device, sending the modified route to the one or more subscriber devices.

18. The computer system of claim 15, wherein the route of the master device is used as the destination of the one or more subscriber devices, and wherein the master device is not in a lead position among a group of travelers.

19. The computer system of claim 15, wherein program instructions to request a role change to the role of the master device comprise:
program instructions to, responsive to detecting that a subscriber device from the one or more subscriber devices has physically passed the master device by greater than a predetermined threshold distance, automatically configure the subscriber device to the role of the master device.

20. The computer system of claim 16, wherein the master device and the one or more subscriber devices follow a different route to a same destination, and wherein the master device and the one or more subscriber devices each start at a different location.
